(19) United States
(12) Patent Application Publication
(10) Pub. No.: US 2009/0262674 A1
(43) Pub. Date: Oct. 22, 2009

(54) COMMUNICATION SYSTEM, TERMINAL, COMMUNICATION METHOD, AND COMMUNICATION PROCESSING PROGRAM

(76) Inventor: Shinji Suzuki, Saitama (JP)

Correspondence Address: YOUNG & THOMPSON, 209 Madison Street, Suite 500, ALEXANDRIA, VA, 22314, US

(21) Appl. No.: 12/442,231

(22) PCT Filed: Sep. 27, 2006
(86) PCT No.: PCT/JP2006/319157

§ 371 Date: Apr. 7, 2009

(51) Int. Cl. H04B 7/00; H04L 12/28

(52) U.S. Cl. 370/310; 370/431

(57) ABSTRACT

When a terminal that is going to perform communication is newly connected, a host terminal in a communication system determines whether a connection sequence can be performed while a time slot assigned to a terminal group or not. When this determination is not mete avoiding use of the time slot enables preventing a communication period of information that should be basically transmitted by using the time slot from being hardly assured and avoiding degradation in communication quality.

### CROSS-REFERENCE TO RELATED APPLICATIONS

This is an application PCT/JP2006/319157, filed Sep. 27, 2006, which was not published under PCT article 21(2) in English.

### BACKGROUND OF THE INVENTION

1. Field of the Invention

The present invention relates to a communication system that performs network communication, a terminal, a communication method, and a communication processing program.

2. Description of the Related Art

With advancement of a network technology, many products come with a function enabling mutual communication through a network. However, any connecting means is required to enable mutual communication.

For example, although a wireless communication technology has rapidly advanced nowadays, guaranteeing uninterrupted communication while maintaining a communication speed of several-ten Mbps anywhere in, e.g., a house is difficult. Guaranteeing a transmission quality is relatively easy in case of cable communication, but wiring lines connecting respective rooms with each other is required to enable communication between devices placed in different rooms, and this is a difficulty for network growth.

Based on these backgrounds, a technology using an electric power line for communication between devices has been recently proposed (see, e.g., JP, A 2001-197146 paragraph 0026 to 0092). According to this technology, data is superimposed on an electric power line to perform communication, and communication can be carried out between respective rooms without newly arranging a dedicated line for network communication since the electric power line is generally arranged in every room at home, for example.

For the above-explained easy implemetability/versatility, many manufacturers or organizations have already proposed various kinds of different communication schemes for the communication technology using the electric power line, and there is a possibility that the plurality of communication schemes may be present in the same electric power line without mutual compatibility. In particular, since each communication scheme can exercise its communication capability to the utmost when using all bands enabling transmission through the electric power line, the plurality of communication schemes highly possibly interfere with each other. To avoid such a situation, a communication scheme that uses, e.g., a frequency multiplication or time-division multiplex technology at the same so that the plurality of schemes can coexist without interfering with each other on the electric power line has been already proposed.

Meanwhile, in the network communication, when a device, e.g., a communication terminal is newly connected with (participates in) a network, device recognition communication to inform this connection is generally carried out. This device recognition communication is performed in order to realize rapid and assured communication by allowing each terminal to recognize which terminal is currently present on the network so that a user can be informed of an operable device or a device from which information can be acquired or by storing a list of communication targets.

Here, since the electric power line is fundamentally intended to supply an electric power and it is not used for communication, normal communication is difficult depending on a wiring state or a load state, and devices connected with the electric power line may be hard to recognize their presence through the device recognition communication in some cases. In particular, when devices are placed in a threshold state where recognition may be or may not be realized depending on each case, device recognition communication (participation notification) may possibly frequently occur. As explained above, when the device recognition communication frequently occurs in a state where a communication band is limited from the beginning to realize coexistence of the plurality of communication schemes, a situation where a band for communication of information to be basically transmitted cannot be assured is assumed, and a communication quality may be possibly disturbed.

As problems to be solved by the present invention, there is the above-explained problem, for example.

### SUMMARY OF THE INVENTION

To solve the above-explained problem, according to the present invention defined in claim 1, there is provided a communication system comprising a terminal group having a plurality of terminals including one first terminal and at least one second terminal, a predetermined communication path occupancy required to perform communication between desired terminals included in the terminal group being assigned, and the first terminal including a first determining unit that determines whether execution of communication for initial setting required for a new second terminal to communicate with the other terminals is possible or not while the communication path occupancy assigned to the terminal group yet in the case that the new second terminal is connected.

To solve the above-explained problem, according to the present invention defined in claim 15, there is provided a terminal provided in a communication system, the communication system including a terminal group having a plurality of terminals, a predetermined communication path occupancy required to perform communication between desired terminals included in the terminal group being assigned, the terminal comprising a determining unit that determines whether execution of communication for initial setting required for a new terminal to communicate with other terminals is possible or not while the communication path occupancy assigned to the terminal group yet in the case that the new terminal is connected.

To solve the above-explained problem, according to the present invention defined in claim 16, there is provided a communication method by which a terminal group including a plurality of terminals occupies communication path occupancy and desired terminals in the terminal group communicate with each other, the communication method comprising steps of a step for determining whether execution of communication for initial setting required for a new terminal to communicate with other terminals is possible or not while the communication path occupancy in the case that the new terminal is connected to perform communication; and a step for performing the communication for initial setting in a period other than the communication path occupancy when the determination is not met.

To solve the above-explained problem, the present invention defined in claim 17 allows a computing unit to execute steps, the computing unit being provided in a terminal, a plurality of the terminals forming a terminal group, communication between desired terminals included in the terminal group being performed by using a predetermined communication path occupancy, the steps comprising a step that determines whether execution of communication for initial setting required for a terminal newly connected to communicate with other terminals is possible or not while the communication path occupancy, and a step for informing the newly connected terminal of executing the communication for initial setting in a period other than the communication path occupancy, when the determination is not met.

### BRIEF DESCRIPTION OF THE DRAWINGS

FIG. 1 is a conceptual system block diagram showing an outline structure of a communication system according to an embodiment of the present invention;

FIG. 2 is a view showing an example of transmission/reception of a coexistence signal between host terminals;

FIG. 3 is a conceptual explanatory view showing an example of a time slot assigned to each terminal group;

FIG. 4 is a flowchart showing a control procedure that is executed by a host terminal in each terminal group with respect to any other terminal in a corresponding group;

FIG. 5 is a conceptual explanatory view showing an example of a data format of a band request output to the host terminal;

FIG. 6 is a view showing a detailed sequence of device list creation/addition processing at a step;

FIG. 7 is a conceptual explanatory view showing a communication behavior at a step S150;

FIG. 8 is a view showing an example of a notification signal supplied from the host terminal to each terminal;

FIG. 9 is a flowchart showing a detailed procedure of out-of-self-slot band processing;

FIG. 10 is a conceptual explanatory view showing a communication behavior in in-new-slot band processing; and

FIG. 11 is a view showing an example of a disconnection sequence in a given terminal group.

### DETAILED DESCRIPTION OF THE PREFERRED EMBODIMENTS

An embodiment according to the present invention will now be explained hereinafter with reference to the accompanying drawings.

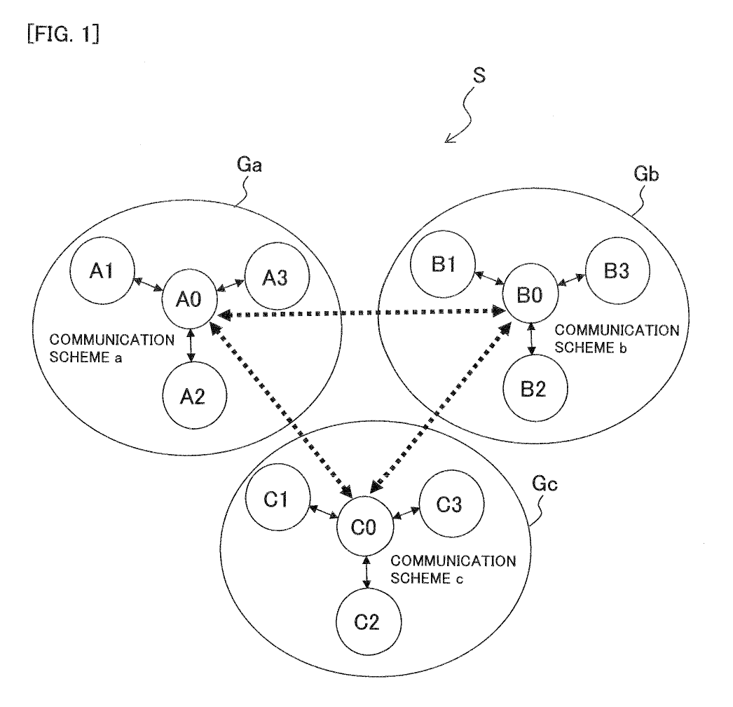

FIG. 1 is a conceptual system block diagram showing a schematic structure of a communication system according to this embodiment. In FIG. 1, this communication system S includes a plurality of (three in this example) terminal groups Ga, Gb, and Gc through a common communication path formed of an electric power line (not shown). Although a detailed explanation will be omitted, these terminal groups Ga, Gb, and Gc are respectively based on communication schemes a, b, and c different from each other (having no compatibility), and the plurality of communication schemes a, b, and c coexist without interfering with each other based on so-called time-division multiplex (TDM) that equally divides a time for utilizing the common electric power line to be sequentially assigned.

The terminal group Ga includes one terminal A0 (a first terminal, a terminal) functioning as a host and a plurality of (three in this example) other terminals A1, A2, and A3 (second terminals).

Likewise, the terminal group Gb includes one terminal B0 (a first terminal, a terminal) functioning as a host and other three terminals B1, B2, and B3 (second terminals), and the terminal group Gc includes one terminal C0 (a first terminal, a terminal) functioning as a host and other three terminals C1, C2, and C3 (second terminals).

It is to be noted that, although not shown in detail, each of the terminals A0 to 3, B0 to 3, and C0 to 3 includes a CPU, an ROM, an RAM, and others as a computing unit, and the CPU performs communication processing in accordance with a program previously stored in the ROM while utilizing a temporary storage function of the RAM.

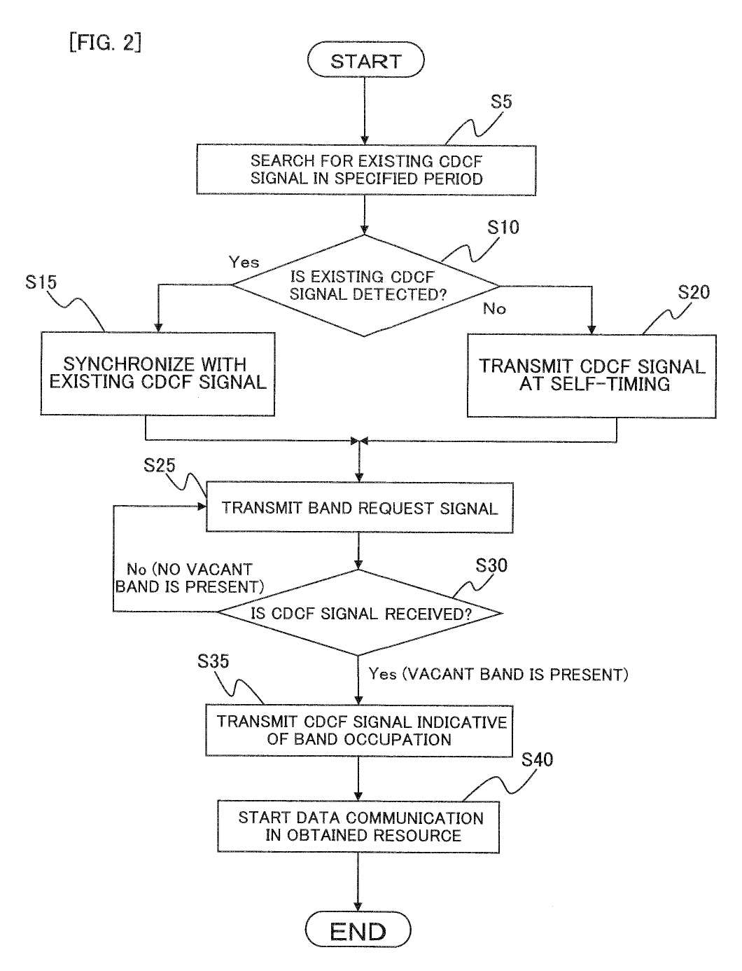

The terminals A0, B0, and C0 as hosts (which will be appropriately referred to as host terminals hereinafter) of the terminal groups Ga, Gb, and Gc communicate with each other to transmit/receive a coexistence signal. FIG. 2 is a flowchart showing an example of transmission/reception of the coexistence signal and also showing communication control executed by the respective host terminals A0, B0, and C0 (a program required to execute this control is stored in the ROM of each of the terminals A0, B0, and C0).

In FIG. 2, first, at a step S5, whether a synchronization signal (e.g., a CDCF signal that is known in a so-called CEPCA technology described at http://www.cepca.org/about_us/Events/past_events/japan_semi nar/CEPCA_SeminarSpecification.pdf in this example) used between the host terminals A0, B0, and C0 has been already transmitted from any other host terminal (e.g., the terminal B0 or C0 if a user's own terminal is the terminal A0) for a predetermined period is checked.

Subsequently, at a step S10, whether an existing CDCF signal has been detected based on checking at the step S5 is determined. If the signal has been detected, the determination is satisfactory, and the processing advances to a step S15 where a timing of the user's host terminal is synchronized with the detected CDCF signal from the other host terminal B0 or C0. On the other hand, if the existing CDCF signal has not been detected at the step S5, the determination at the step S10 is not satisfactory, and the processing advances to a step S20 where the CDCF signal is transmitted to the other host terminal B0 or C0 at a timing of the user's host terminal.

Upon completion of the step S15 or the step S20, the processing proceeds to a step S25, a band request signal is transmitted to the other host terminal B0 or C0, and whether the CDCF signal has been received (in other words, whether a vacant band is present) is determined at a subsequent step S30.

If a vacant band is not present, the determination at the step S30 is not met, and the processing returns to the step S25 to again transmit the band request signal. If a vacant band is present, the determination is satisfactory, and the processing advances to a step S35.

The CDCF signal indicative of band occupation to the other host terminal B0 or C0 at the step S35, and then data communication with the user's terminal group (e.g., the terminals A1, A2, and A3 in the terminal group Ga in case of the host terminal A0) in an acquired resource at a step S40, thereby terminating this flow.

It is to be noted that the above has explained the example of the host terminal A0, but the same processing can be applied to the host terminals B0 and C0.

As explained above, although the respective terminal groups Ga, Gb, and Gc use the communication schemes different from each other, each time slot (a communication path occupancy) of TDM for each scheme is assigned based on such communication between host terminals A0, B0, and C0 as shown in FIG. 2.

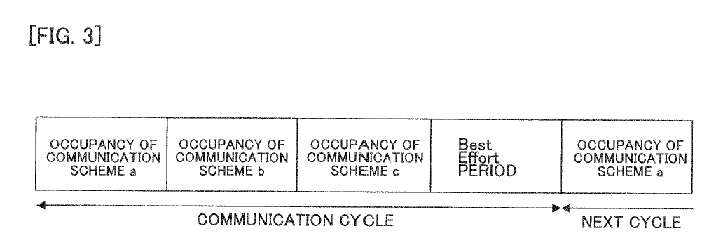

FIG. 3 is a conceptual explanatory view showing an example of an assigned slot. In FIG. 3, in this example, one communication cycle of TDM includes a slot for the terminal group Ga (in other words, the communication scheme a), a slot of the terminal group Gb (the communication scheme b), a slot of the terminal group Gc (the communication scheme c), and a Best Effort period as a non-occupancy prepared as a period that is not occupied by any one of the terminal groups Ga, Gb, and Gc (for, e.g., a measuring device such as a sensor) in accordance with a structure where the communication system S includes the three terminal groups Ga, Gb, and Gc.

For example, the respective terminal groups A0, A1, A2, and A3 belonging to the terminal group Ga can communicate with each other in the slot for the terminal group Ga (in other words, the communication scheme a) alone, and they are prohibited from communicating with each other in the slots for the other terminal groups Gb and Gc (in other words, the communication schemes b and c). This can be likewise applied to the terminal groups Gb and Gc.

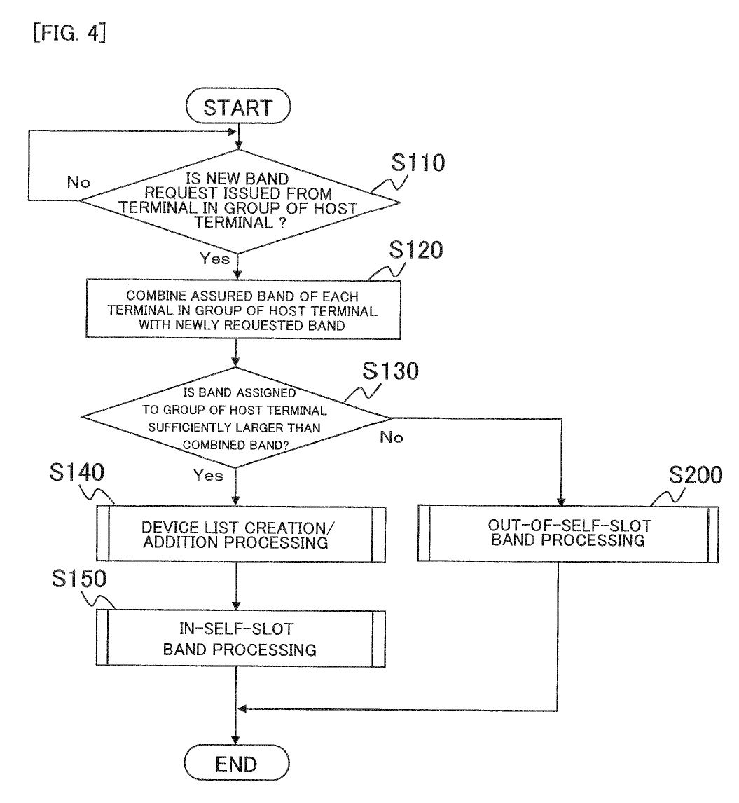

FIG. 4 is a flowchart showing a control procedure executed by the host terminals A0, B0, and G0 in the respective terminal groups Ga, Gb, and Gc with respect to the other terminals A1 to 3, B1 to 3, and C1 to 3 in the corresponding groups (it is to be noted that a program required to execute this control is stored in the ROM of each of the terminals A0, B0, and C0).

When each of terminals A1 to 3, B1 to 3, and C1 to 3 other than the host terminals A0, B0, and C0 in the respective terminal groups Ga, Gb, and Gc is connected with a network, it outputs a connection processing request (a band request) for assuring a communication band to each host terminal A0, B0, or C0 (request outputting unit). The host terminal A0, B0, or C0 determines whether the connection processing request (the band request) has been issued from any one of the other terminals A1 to 3, B1 to 3, or C1 to 3 in the terminal group Ga, Gb, or Gc to which the host terminal belongs to.

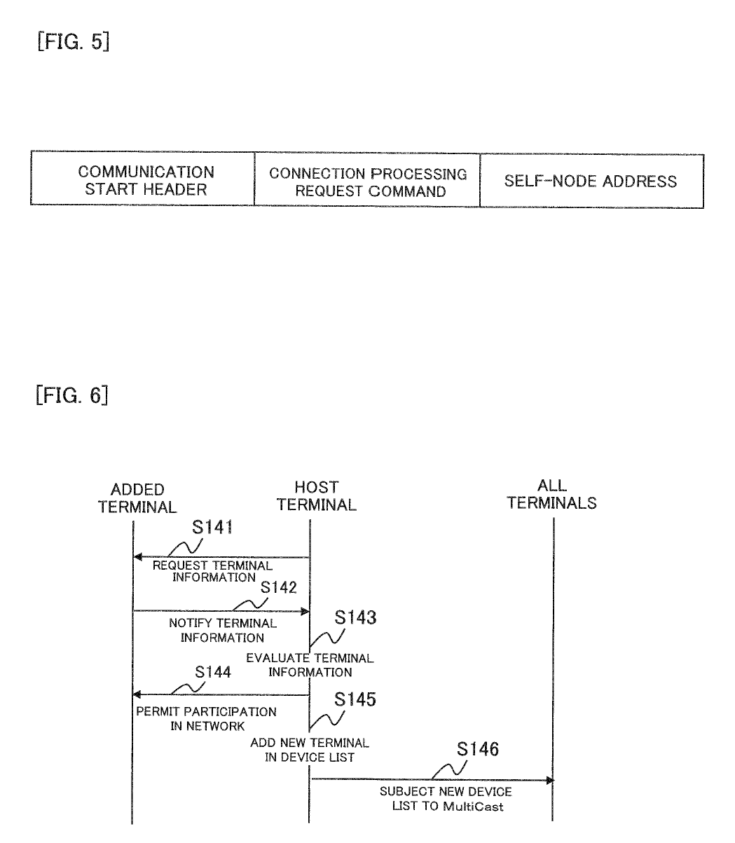

It is to be noted that this band request is transmitted based on multicast, the terminals other than the host terminals A0, B0, and C0 ignore this signal. FIG. 5 is a conceptual explanatory view showing an example of a data format of this band request. As shown in the drawing, in this example, the data format includes a communication start header, a connection processing request (band request) command forming a request main body, and a self-node (terminal group to which the host terminal belongs to) address information.

Again referring to FIG. 4, when such a band request is input, the determination at a step S110 is met, and the processing advances to a step S120.

At the step S120, a band already assured by the terminals A1 to 3, B1 to 3, or C1 to 3 in the terminal group Ga, Gb, or Gc to which the host terminal belongs to is combined with an assurance request band of the terminal that has newly requested connection at the step S110 (band combining unit).

Subsequently, at a step S130, as explained above with reference FIG. 2 or 3, a band of each slot assigned to the terminal group Ga, Gb, or Gc of the host terminal based on communication between the host terminals A0, B0, and C0 is compared with a band obtained from the combining operation at the step S120, and whether the assigned band has a greater margin than the combined band, i.e., whether the following expression can be achieved is determined (comparing unit, first determining unit, and determining unit):

(a self-node communication enabling band)−(the combined band)>(a preset threshold value) (Expression 1)

When the assigned band (the self-node communication enabling band) is sufficiently larger than the combined band (the self-node communication enabling band has a great margin), Expression 1 is satisfied, the determination at the step S130 is met, and the processing advances to a step S140.

At the step S140, device list creation/addition processing of creating a device list including the terminals A0 to 3, B0 to 3, and C0 to 3 having the band requested and assured at this point in time (or creating a device list having a terminal that has requested new connection added therein).

FIG. 6 is a view showing a detailed sequence of the device list creation/addition processing at the step S140. In FIG. 6, first, at a step S141, terminal information is requested with respect to a corresponding terminal (which has requested new connection) (any one in A0 to 3, B0 to 3, or C0 to 3). Various kinds of evaluations of the corresponding terminal are performed at a step S143 based on the terminal information transmitted from the corresponding terminal at a step S142 in response to this request, and then a network participation allowance notification is transmitted to the corresponding terminal at a step S144. It is to be noted that the steps S141, the step S142, and the step S144 correspond to communication for initial setting. Further, the corresponding new terminal is added to the previously utilized device list at a step S145 in response to transmission of the notification, and then this new device list is transmitted to all terminals including the corresponding new terminal (excluding the host terminal).

Again referring to FIG. 4, when the step S140 is terminated as explained above, the processing advances to in-self-slot band processing at a step S150, and communication (data transmission/reception) is performed by using all terminals in the terminal group written in the device list created at the step S140.

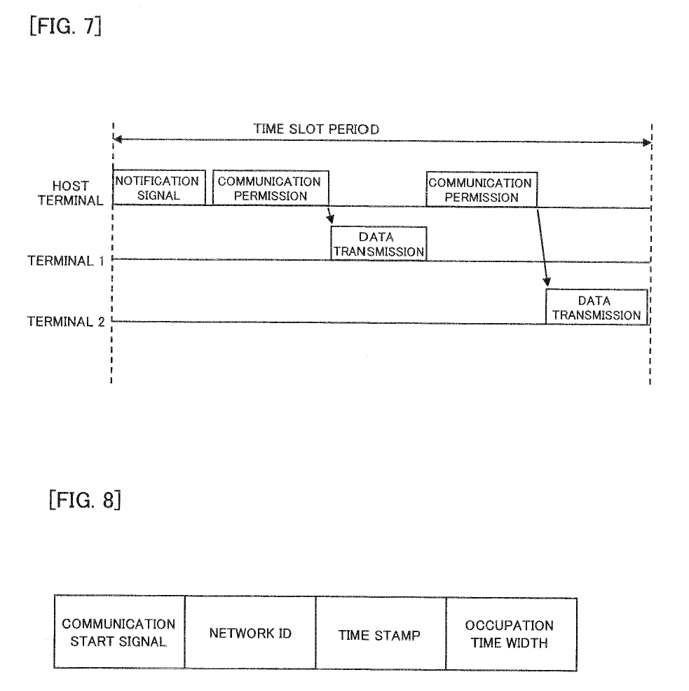

FIG. 7 is a conceptual explanatory view showing a communication behavior at this moment.

That is, each of the host terminal A0 adopting the communication scheme a, the host terminal B0 adopting the communication scheme b, and the host terminal C0 adopting the communication scheme c detects a zero cross point of a power supply and generates an internal clock synchronized with the detected zero cross point. At this time (as explained above in conjunction with FIG. 2), clocks of the respective terminals are synchronized by using the CDCF signal, and an occupancy of each communication scheme a, b, or c depicted in FIG. 3 is managed based on a time using the CDCF signal as a starting point. As a result, each host terminal A0, B0, or C0 can detect its own occupancy (a slot) based on a CDCF signal generation clock time and the clock subjected to power supply synchronization.

As explained above, when the occupancy (the slot) assigned to a corresponding group comes, the host terminal A0 (or B0 or C0) first transmits a notification signal including occupancy start and an occupancy time width to all the terminals in the terminal group written in the device list created at the step S140 based on multicast as shown in FIG. 7.

FIG. 8 is a view showing an example of the notification signal transmitted from the host terminal A0, B0, or C0 to the respective terminals A0 to 3, B0 to 3, or C0 to 3. In this example, a network ID of each terminal group Ga, Gb, or Gc and a time stamp (which is not necessarily required) stamped by the host terminal A0, B0, or C0 in each group based on a self-clock reference are included in addition to a communication start signal indicative of start of the occupancy and the occupancy time width information.

Each of the terminals A1 to 3, the B1 to 3, or C1 to 3 that has received the above-explained notification signal detects the communication start signal and the network ID included in the notification signal to detect start of a communication period of the communication scheme a, b, or c to which this terminal belongs. Furthermore, at this time, correcting the clock of this terminal by using the time stamp signal enables achieving clock synchronization between the respective terminals A1 to 3, B1 to 3, or C1 to 3 adopting the same scheme a, b, or c, and the occupancy time width information is used to detect a communication enabling time width.

Thereafter, the host terminal A0 (or B0 or C0) sequentially outputs a communication allowance signal to the respective terminals A1 to 3 (or B1 to 3 or C1 to 3) (having the band already assured upon issuance of the connection request) in the corresponding terminal group Ga (or Gb or Gc) in a predetermined order. Each terminal having received this signal starts communication in the terminal group Ga (or Gb or Gc) based on a predetermined protocol determined by the communication scheme a (or b or c) associated with the terminal group Ga (or Gb or Gc). Moreover, when the occupancy time width specified by the occupancy time width information passes, mutual communication in the group is stopped.

Again referring to FIG. 4, when the in-self-slot band processing at the step S150 is completed as explained above, the flow depicted in FIG. 4 is terminated.

On the other hand, in FIG. 4, when the assigned band (the self-node communication enabling band) is smaller than or not significantly larger than the combined band (the self-node communication enabling band has no margin), Expression 1 is not satisfied, namely, a relationship represented by the following expression is provided, and the processing advances to a step S200:

(the self-node communication enabling band)−(the combined band)≦(a preset threshold value) (Expression 2)

At the step S200, since the self-node communication enabling band has no margin with respect to the combined band and insufficiency of bands occurs if nothing is done (the self-node communication enabling band is fragile), out-of-self-slot band processing of performing communication in the terminal group in a band other than the assigned band is performed.

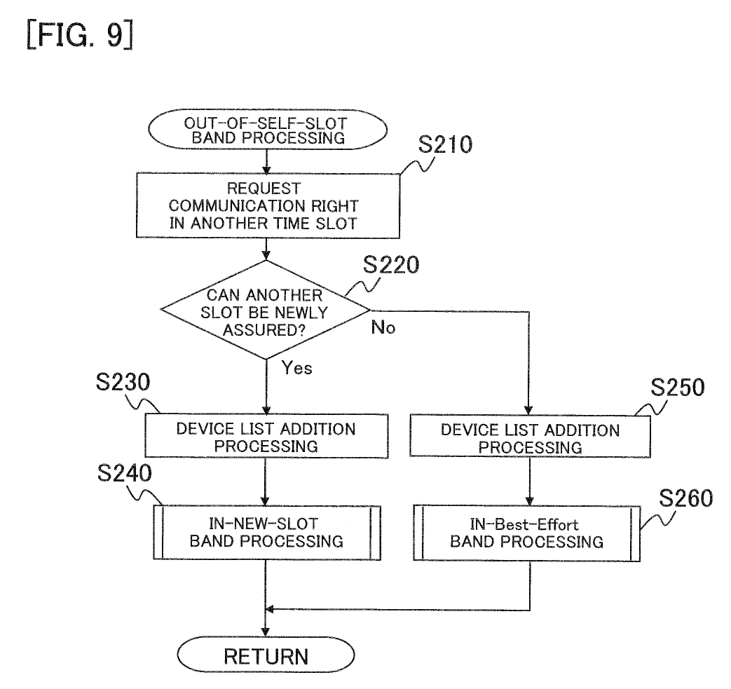

FIG. 9 is a flowchart showing a detailed procedure of this out-of-self-slot band processing (it is to be noted that a program required to execute this control is stored in the ROM in the terminal A0, B0, or C0).

In FIG. 9, first, at a step S210, each of the host terminals A0, B0, and C0 outputs a signal requesting a communication right in any other slot than the already assigned slot to any host terminal other than itself.

Subsequently, the processing advances to a step S220, and whether another time slot (a communication path occupancy) has been newly assured (assigned) is determined based on arbitration with the other host terminal using the communication right request at the step S210 (second determining unit). When another slot has been assured, the determination at the step S220 is met, and the processing proceeds to a step S230.

At the step S230, like the step S140, device list creation/addition processing of creating a device list including each of the terminals A0 to 3, B0 to 3, or C0 to 3 having the band requested and assured at this point in time (or creating a device list having a terminal that has requested new connection added thereto) is performed. Since the detailed sequence in this example is the same as that depicted in FIG. 6, an explanation thereof will be omitted.

Subsequently, processing advances to in-new-slot band processing at a step S240, and communication (data transmission/reception) is performed by using all the terminals in the terminal group written in the device list created at the step S230 in the new slot assured at the step S220 (first notifying unit).

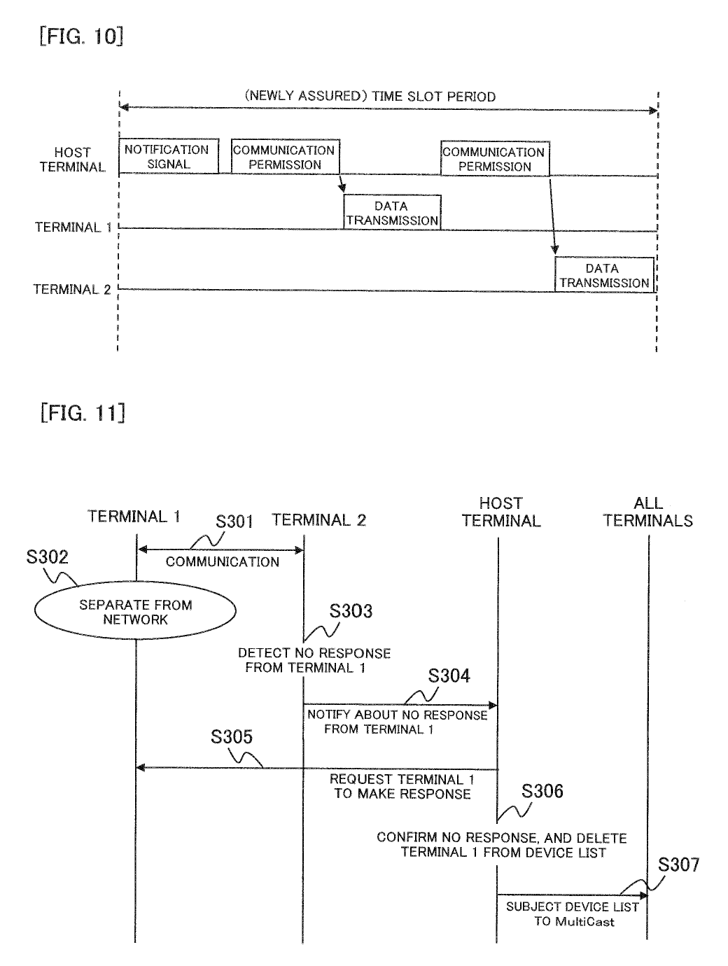

FIG. 10 is a conceptual explanatory view that shows a communication behavior at this moment and is equivalent to FIG. 7. In FIG. 10, when an occupancy (a slot) newly assigned to a corresponding group comes, the host terminal A0 (or B0 or C0) transmits a notification signal to all the terminals in the terminal group written in the device list created at the step S230 like FIG. 7 based on multicast, and then the communication allowance signal is sequentially output to the respective terminals A1 to 3 (or B1 to 3 or C1 to 3) in the corresponding terminal group Ga (or Gb or Gc) in a predetermined order. As a result, the respective terminals start communication in the corresponding terminal group Ga (or Gb or Gc) and stop mutual communication when an occupancy time width passes.

Again referring to FIG. 9, when the in-new-slot band processing at the step S240 is completed as explained above, the step S200 shown in FIG. 4 is terminated, thereby finishing the flow.

On the other hand, when another time slot (a communication path occupancy) cannot be assured at the step S220 depicted in FIG. 9, the determination is not met, and the processing advances to a step S250.

At the step S250, like the step S230 or the step S140, device list creation/addition processing of creating a device list including the terminals A0 to 3, B0 to 3, or C0 to 3 each having a band requested and assured at this point in time (or creating a device list having a terminal that has requested new connection added thereto) is carried out. A detailed sequence at this moment is equivalent to that shown in FIG. 6, thereby omitting an explanation thereof.

Then, the processing advances to a step S260. In the Best Effort period explained above (prepared as a period that is not occupied by any terminal group Ga, Gb, or Gc), all the terminals in the terminal group written in the device list created at the step S250 perform communication (data transmission/reception) (first notifying unit). However, since arbitration of the terminal groups Ga, Gb, and Gc (i.e., the host terminals A0, B0, and C0) is not performed in this period, communication may possibly fail when communication is carried based on the plurality of communication schemes a, b, and c at the same time. Therefore, it is desirable for each of the terminal groups Ga, Gb, and Gc to have a unit that detects a communication failure when communication is performed at least in this Best Effort period (described later) and a unit that effects retransmission when communication fails.

Again referring to FIG. 9, when the in-new-slot band processing at the step S260 is completed as explained above, the step S200 in FIG. 4 is terminated, thereby finishing the flow.

As explained above, the communication system S according to this embodiment is the communication system S in which a plurality of terminals including one first terminal (the host terminal A0, B0, or C0 in this example) and at least one second terminal A1 to 3, B1 to 3, or C1 to 3 constitute one terminal group Ga, Gb, or Gc and a predetermined communication path occupancy required to perform communication between desired terminals in a corresponding terminal group is assigned, and it is characterized in that the first terminal A0, B0, or C0 has a first determining unit (the step S130 in this example) that determines whether communication for initial setting (the steps S141, S142, and S144 in this example) required for a new second terminal in A1 to 3, B1 to 3, or C1 to 3 to communicate with the other terminals can be carried out or not while the communication path occupancy assigned to the terminal group Ga, Gb, or Gc yet in the case that the new second terminal in A1 to 3, B1 to 3, C1 to 3 is connected.

In the communication system S according to this embodiment, the communication path occupancy is assigned to each of the plurality of terminal groups Ga, Gb, and Gc each including the first terminal A0, B0, or C0 and the second terminals A1 to 3, B1 to 3, or C1 to 3, and the respective terminals A0 to 3, B0 to 3, or C0 to 3 perform mutual communication in the occupancy of the corresponding terminal group Ga, Gb, or Gc as a general rule. As a result, different systems can be configured in accordance with each of the terminal groups Ga, Gb, and Gc, and the communication schemes a, b, and c of the plurality of systems can coexist without interfering with each other. Further, when the second terminal in A1 to 3, B1 to 3, or C1 to 3 that is going to perform communication is newly connected in each terminal group Ga, Gb, or Gc, connection is not achieved as it is, but the first determining unit S130 determines whether the communication S141, S142, and S144 for initial setting required to achieve the new connection can be carried out in the assigned communication path occupancy.

As a result, the communication S141, S142, and S144 for initial setting can be effected by using the communication path occupancy only when the determination is met, and the communication path occupancy is not utilized when the determination is not met. Consequently, a communication period for information that should be basically transmitted by using the communication path occupancy can be prevented from being hardly assured, thereby avoiding degradation in communication quality.

Further, the terminal (the host terminal A0, B0, or C0 in this example) according to this embodiment is the terminal A0, B0, or C0 which has a structure where a plurality of terminals A0 to 3, B0 to 3, or C0 to 3 constitute one terminal group Ga, Gb, or Gc and is provided in the communication system S to which a predetermined communication path occupancy required to perform communication between desired terminals included in the corresponding terminal group is assigned, and it is characterized by having a determining unit (the step S130 in this example) that determines whether communication S141, S142, and S144 for initial setting required for another new terminal selected from A1 to 3, B1 to 3, or C1 to 3 to communicate with the other terminals A0 to 3, B0 to 3, or C0 to 3 can be performed or not while the communication path occupancy already assigned to the terminal group Ga, Gb, or Gc in the case that the terminal A0, B0, or C0 is connected with this new terminal in A1 to 3, B1 to 3, or C1 to 3.

According to the terminal A0, B0, or C0 of this embodiment, in the communication system S, the communication path occupancy is assigned to each of the plurality of terminal groups Ga, Gb, and Gc each including the terminal A0, B0, or C0 and the terminals A1 to 3, B1 to 3, or C1 to 3, and the respective terminals A0 to 3, B0 to 3, or C0 to 3 perform communication with each other in the occupancy of the corresponding terminal group Ga, Gb, or Gc as a general rule. As a result, different systems are configured in accordance with each of the terminal groups Ga, Gb, and Gc, and the communication schemes a, b, and c of the plurality of systems can coexist without interfering with each other. Further, in each terminal group Ga, Gb, or Gc, when each of the terminals A1 to 3, B1 to 3, or C1 to 3 that is to perform communication is newly connected with the terminal A0, B0, or C0, connection is not directly achieved, but the determining unit S130 determines whether the communication S141, S142, and S144 for initial setting required to achieve this new connection can be effected in the already assigned communication path occupancy.

As a result, the communication S141, S142, and S144 for initial setting can be performed by using the communication path occupancy only when the determination is met, and use of the communication path occupancy can be avoided when the determination is not met. Consequently, a communication period for information that should be fundamentally transmitted can be prevented from being hardly assured, degradation in communication quality can be avoided.

Furthermore, the communication method according to this embodiment is the communication method that enables the terminal group Ga, Gb, or Gc including the plurality of terminals A0 to 3, B0 to 3, or C0 to 3 to occupy a predetermined communication path occupancy so that desired terminals A0 to 3, B0 to 3, or C0 to 3 in the corresponding terminal group Ga, Gb, or Gc can communicate with each other, and the communication method is characterized in that whether communication S141, S142, and S144 for initial setting required for a new terminal to communicate with the other terminals can be performed or not while the communication path occupancy in the case that this new terminal is connected to perform communication and that the communication for initial setting is carried out in a period other than the communication path occupancy when the determination is not met.

According to the communication method of this embodiment, the communication path occupancy is assigned to the terminal group Ga, Gb, or Gc including the plurality of terminals A0 to 3, B0 to 3, or C0 to 3, and the respective terminals A0 to 3, B0 to 3, or C0 to 3 communicate with each other in the occupancy of the corresponding terminal group Ga, Gb, or Gc. As a result, even if different systems can be constituted in accordance with each of the terminal groups Ga, Gb, and Gc and the same physical medium is shared as a communication path, the communication schemes a, b, and c of the plurality of systems can coexist without interfering with each other. Moreover, when one in the terminals A1 to 3, B1 to 3, or C1 to 3 that is to perform communication in each terminal group Ga, Gb, or Gc is newly connected, connection is not achieved as it is, but whether the communication S141, S142, and S144 for initial setting required to attain this new connection can be carried out in the already assigned communication path occupancy is determined, and the communication S141, S142, and S144 for initial setting are performed in a period other than the communication path occupancy when the determination is not met.

When the communication path occupancy is used to effect the communication S141, S142, and S144 for initial setting only when the determination is met in this manner, a communication period for information that should be basically transmitted by using the communication path occupancy can be prevented from being hardly assured, and degradation in communication path can be avoided.

Additionally, the communication processing program according to this embodiment is characterized by allowing computing unit provided in the terminal A0, B0, or C0 to execute: determining whether the communication S141, S142, and S144 for initial setting required for a newly connected terminal to communicate with other terminals can be performed or not while a predetermined communication path occupancy in the case that the terminal group Ga, Gb, or Gc including the plurality of terminals A0 to 3, B0 to 3, or C0 to 3 occupies the communication path occupancy and desired terminals A0 to 3, B0 to 3, or C0 to 3 in the corresponding terminal group Ga, Gb, or Gc communicate with each other; and informing the newly connected terminal that the communication S141, S142, and S144 for initial setting are performed in a period other than the communication path occupancy when the determination is not met.

In the communication processing program according to this embodiment, the terminal group Ga, Gb, or Gc including the plurality of terminals A0 to 3, B0 to 3, or C0 to 3 occupies the communication path occupancy, and the respective terminals A0 to 3, B0 to 3, or C0 to 3 communicate with each other in the corresponding occupancy. As a result, even if different systems can be constituted in accordance with each of the terminal groups Ga, Gb, and Gc and the same physical medium is shared as a communication path, the communication schemes a, b, and c of the plurality of systems can coexist without interfering with each other. Further, when one in the terminals A1 to 3, B1 to 3, or C1 to 3 that is to perform communication in each terminal group Ga, Gb, or Gc is newly connected, connection is not achieved as it is, but whether the communication S141, S142, and S144 for initial setting required to achieve this new connection can be performed in the communication path occupancy is determined, and the communication S141, S142, and S144 for initial setting are carried out in a period other than the communication path occupancy when the determination is not met.

When the communication path occupancy is used to effect the communication S141, S142, and S144 for initial setting only when the determination is met in this manner, a communication period for information that should be basically transmitted by using the communication path occupancy can be prevented from being hardly assured, and degradation in communication path can be avoided.

In the communication system S according to this embodiment, the first determining unit S130 is characterized by making a determination in accordance with a band enabling communication in the already assigned communication path occupancy and a band utilized by the plurality of terminals A0 to 3, B0 to 3, or C0 to 3 effecting communication.

As a result, when the band utilized by the plurality of terminals A0 to 3, B0 to 3, or C0 to 3 for communication is extremely larger than the band in the communication path occupancy assigned to the corresponding terminal group Ga, Gb, or Gc, it can be determined that the band is considered to be fragile and the communication S141, S142, and S144 for initial setting cannot be effected in the communication path occupancy.

Further, the communication system S according to the foregoing embodiment is characterized in the first determining unit S130 includes a comparing unit that performs comparison to check whether a difference between a band enabling communication in the already assigned communication path occupancy and a band utilized by the plurality of terminals A0 to 3, B0 to 3, or C0 to 3 that perform communication is not smaller than a predetermined threshold value (which may be variable in accordance with each communication scheme) or not.

Consequently, when the band utilized by the plurality of terminals A0 to 3, B0 to 3, or C0 to 3 for communication is extremely larger than the band in the communication path occupancy assigned to the corresponding terminal group Ga, Gb, or Gc and a difference between these bands is less than a predetermined value, it can be determined that the band is considered to be fragile and the communication S141, S142, and S144 for initial setting cannot be performed in the communication path occupancy.

Moreover, the communication system S according to the foregoing embodiment is characterized in that each of the second terminals A1 to 3, B1 to 3, or C1 to 3 includes a request outputting unit that outputs a band request required for communication with other terminals, the first terminal A0, B0, or C0 has a band combining unit (the step S120 in this example) that combines a band required by the second terminal in A1 to 3, B1 to 3, or C1 to 3 in communication by using the request outputting unit and a band requested by the new terminal in A1 to 3, B1 to 3, or C1 to 3 as a band utilized by the plurality of terminals A0 to 3, B0 to 3, or C0 to 3 that perform communication, and the comparing unit S130 compares a band enabling communication in the already assigned communication path occupancy and a comparison result obtained by the band combining unit S120.

As a result, when a sum of the requested band of the second terminal in A1 to 3, B1 to 3, or C1 to 3 that is in communication and the requested band of the new second terminal in A1 to 3, B1 to 3, or C1 to 3 calculated by the band combining unit S120 is extremely larger than the band in the communication path occupancy assigned to the corresponding terminal group Ga, Gb, or Gc and a difference between these bands is less than a predetermined value, it can be determined that the band is considered to be fragile and the communication S141, S142, and S144 for initial setting cannot be carried out in the communication path occupancy.

Furthermore, the communication system S according to the foregoing embodiment is characterized in that the first terminal A0, B0, or C0 has a first notifying unit (the step S240 or the step S260 in this example) that notifies at least the second terminal in A1 to 3, B1 to 3, or C1 to 3 of execution of the communication S141, S142, and S144 for initial setting in a period other than the communication path occupancy already assigned to the terminal group Ga, Gb, or Gc when the determination of the first determining unit S130 is not met.

When the determination of the first determining unit S130 is not met, using a period other than the communication path occupancy enables preventing a communication period of information that should be basically transmitted by using the communication path occupancy from being hardly assured and avoiding degradation in communication quality.

Additionally, the communication system S according to the foregoing embodiment is characterized by having a second determining unit (the step S220 in this example) that determines whether a new communication path occupancy is assured or not besides the already assigned communication path occupancy when the determination of the first determining unit S130 is not met.

Consequently, execution of the communication S141, S142, and S144 for initial setting using the new communication path occupancy and execution of the communication S141, S142, and S144 for initial setting using any other period are switched in accordance with whether the determination of the second determining unit S220 is met, thereby preventing a communication period of information that should be basically transmitted by using the communication path occupancy from being hardly assured.

Further, the communication system S according to the foregoing embodiment is characterized in that the first notifying mans S260 notifies at least the new second terminal in A1 to 3, B1 to 3, or C1 to 3 of execution of the communication S141, S142, and S144 for initial setting in a non-occupancy prepared as a period that is not occupied by any terminal group Ga, Gb, or Gc when the determination of the second determining unit S220 is not met.

As a result, when the determination of the second determining unit S220 is met, using the non-occupancy usually prepared for a measuring device, e.g., a sensor enables preventing a communication period of information that should be basically transmitted by using the communication path occupancy from being hardly assured.

Further, the communication system S according to the foregoing embodiment is characterized in that the first notifying unit S240 notifies at least the new second terminal in A1 to 3, B1 to 3, or C1 to 3 of execution of the communication S141, S142, and S144 for initial setting in a newly assigned communication path occupancy when the determination of the second determining unit S220 is met.

As a result, when the determination of the second determining unit S220 is met, using the newly assigned communication path occupancy besides the already assigned communication path occupancy enables preventing a communication period of information that should be basically transmitted by using the communication path occupancy from being hardly assured.

Further, the communication system S according to the foregoing embodiment is characterized in that the plurality of terminal groups Ga, Gb, and Gc are provided through a common communication path formed of the same physical medium with each other, and communication path occupancies different from each other are assigned respectively to the plurality of provided terminal groups Ga, Gb, and Gc.

Even if different systems are configured in accordance with each of the terminal groups Ga, Gb, and Gc and the communication schemes a, b, and c of the systems are different from each other, assigning the different communication path occupancies to the plurality of terminal groups Ga, Gb, and Gc enables the communication schemes a, b, and c to coexist without interfering with each other.

Furthermore, the communication system S according to the foregoing embodiment is characterized in that the common communication path connecting the plurality of terminal groups Ga, Gb, and Gc is formed by power line communication as the same physical medium.

When the electric power line is used, the communication system S can be configured without newly providing a dedicated line for communication, thereby readily realizing communication between chambers. Although a possibility that the plurality of communication schemes a, b, and c coexist is high because of easy implementability/versatility, the plurality of communication schemes a, b, and c can coexist without interfering with each other in such a case. Moreover, since the electric power line is fundamentally intended to supply electric power and considerably restricted and bands enabling communication are also restricted, an effect of preventing a communication quality of information that should be basically transmitted by using the communication path occupancy from being degraded is particularly high.

It is to be rioted that this embodiment is not restricted to the above explanation and can be modified in many ways. Such modifications will now be sequentially explained hereinafter.

(1) When Opening Connection Sequence

In FIG. 9 described above, after the determination at the step S220 is met and the connection sequence (the communication for initial setting) at the steps S141, S142, and S144 is terminated in a time slot newly assured at the steps S240, the corresponding host terminal A0, B0, or C0 may rapidly open the new slot assured for this connection sequence (second notifying unit).

In the communication system S according to this modification, the first terminal A0, B0, or C0 has the second notifying unit that notifies any other terminal group than the terminal group Ga, Gb, or Gc of end of occupation of a newly assigned communication path occupancy when the communication S141, S142, and S144 for initial setting are finished.

When the communication S141, S142, and S144 for initial setting for new connection are terminated, opening the communication path occupancy additionally acquired for this connection enables suppressing bands occupied by the communication scheme of the corresponding terminal group Ga, Gb, or Gc in the entire system.

(2) When Executing Disconnection Sequence by Same Method

That is, when communication with at least one terminal in the terminals A1 to 3, B1 to 3, or C1 to 3 becomes impossible, whether an assigned region has a margin is determined based on a combination of bands in regard to communication for disconnection setting (a disconnection sequence) required to share communication inexecution (communication disconnection) information of this terminal with the other terminals like the example (equal to the step S130 in FIG. 4) of communication for initial setting (the connection sequence) according to the foregoing embodiment, another slot newly assured separately from a time slot assigned from the beginning or a Best Effort period may be used to effect communication when there is no margin.

The communication system S according to this modification is characterized in that the first terminal A0, B0, or C0 has a third determining unit (the same procedure as the step S130 in this example) that determines whether execution of communication for disconnection setting is possible or not while the assigned communication path occupancy when communication with at least one second terminal A1 to 3, B1 to 3, or C1 to 3 becomes impossible, the communication for disconnection setting being required to share communication inexecution (communication disconnection) information of the second terminals with other than at least one of the second terminal.

As a result, in regard to communication for disconnection setting, the same effect as that of the communication S141, S142, and S144 for initial setting can be obtained. That is, communication for disconnection setting can be carried out by using a communication path occupancy of the corresponding terminal group Ga, Gb, or Gc only when the determination by the third determining unit is met, and this communication path occupancy can be prevented from being used when the determination is not met. As a result, in regard to communication for disconnection setting, a communication period of information that should be basically transmitted by using a communication path occupancy can be prevented from being hardly assured. Therefore, degradation in communication path can be securely avoided.

(3) Example of Another Method of Disconnection Sequence

In regard to the disconnection sequence, another sequence may be used to effect communication.

FIG. 11 is a view showing an example of the disconnection sequence in a given terminal group (Ga will be taken as an example in this explanation, but Gb and Gc can be likewise exemplified). In FIG. 11, a consideration will be given as to a situation where a terminal 1 (any one in A1 to 3) is separated from a network and communication is disabled at a step S302 in a state where the terminal 1 in the group Ga communicates with a terminal 2 (another terminal in A1 to 3).

When a situation where the terminal 1 is separated and does not make a response is detected by the terminal 2 at a step S303, the host terminal A0 is informed of this situation at a step S304.

The host terminal A0 transmits a response request to the terminal 1 at a step S305 in accordance with information provided at the step S304. Subsequently, upon confirming no response, the corresponding terminal 1 (any one in the terminals A1 to 3) is deleted from the above-explained device list concerning the network communication at a step S306, and then the new device list (obtained after deletion) is transmitted to all terminals (excluding the host terminal) based on multicast at a step S307 (forcible disconnection controlling unit).

In this modification, the first terminal A0, B0, or C0 is characterized by having a forcible disconnection controlling unit (the steps S306 and S307 in this example) that performs communication for disconnection setting while the assigned communication path occupancy when communication with at least one of second terminal in the terminals A1 to 3, B1 to 3, or C1 to 3 becomes impossible, the communication for disconnection setting being required to share communication inexecution (communication disconnection) information of the second terminals with the other second terminals than the at least one of the second terminal.

When the second terminal in the terminals A1 to 3, B1 to 3, or C1 to 3 that cannot perform communication is present, immediately forcibly carrying out the communication for disconnection setting in an assigned communication path occupancy enables avoiding wasteful occupation of a communication period due to occurrence of a connection request from other terminals with respect to the incommunicable second terminal in A1 to 3, B1 to 3, or C1 to 3. In particular, when this second terminal in A1 to 3, B1 to 3, or C1 to 3 has a function as a hub, the connection request may be possibly frequently generated, and hence an effect is remarkable.

(4) Others

(4-A) Although the above has explained the example where a given terminal functions as a host and is functionally discriminated from any other terminals, the present invention is not restricted thereto, a function equivalent to that of the host function may be carried out by a plurality of (or all of) terminals like distributed processing.
(4-B) In regard to a coexistence scheme of the respective communication schemes a, b, and c, coexistence based on the CEPCA scheme has been exemplified in the above explanation, but the present invention is not restricted thereto. That is, particulars of a scheme are not concerned as long as a scheme that can realize coexistence based on time-division multiplex (TDM) in accordance with any coexistence rule is adopted.
(4-C) The above has explained the example where the transmission medium is a shared electric power line, but the present invention is not restricted thereto, and the same method can be used in, e.g., wireless communication as long as it is a method allowing coexistence of a plurality of schemes by using the same physical medium.

This modification is characterized in that a common communication path to which the plurality of terminal groups Ga, Gb, and Gc are connected is configured by wireless communication as the same physical medium.

As a result, in communication using a wireless transmission path, a communication period of information that should be basically transmitted by using a communication path occupancy can be prevented from being hardly assured, thereby avoiding degradation in communication quality.

The communication system S according to the foregoing embodiment is the communication system having a structure where a plurality of terminals including one host terminal A0, B0, or C0 and at least one terminal in A1 to 3, B1 to 3, or C1 to 3 constitute one terminal group Ga, Gb, or Gc and a predetermined time slot required to perform communication between desired terminals included in a corresponding terminal group is assigned, and the host terminal A0, B0, or C0 determines whether the communication S141, S142, and S144 for initial setting required for a new terminal in A1 to 3, B1 to 3, or C1 to 3 to communicate with the other terminals A0 to 3, B0 to 3, or C0 to 3 can be carried out or not while a time slot already assigned to the terminal group Ga, Gb, or Gc at the step S130 when the new terminal in A1 to 3, B1 to 3, or C1 to 3 is connected.

As a result, different systems can be constituted in accordance with each of the terminal groups Ga, Gb, and Gc, and the communication schemes a, b, and c of the plurality of systems can coexist without interfering with each other. Further, when the terminal in the terminals A1 to 3, B1 to 3, or C1 to 3 that is going to perform communication in each terminal group Ga, Gb, or Gc is newly connected, connection is not achieved as it is, but a determination is made upon whether the communication S141, S142, and S144 for initial setting for achieving the new connection can be carried out in the already assigned time slot at the step S130. Therefore, the assigned time slot is used to carry out the communication S141, S142, and S144 for initial setting only when the determination at the step S130 is met, and this time slot can be prevented from being used when the determination is not met. As a result, a communication period of information that should be basically transmitted by using the time slot can be prevented from being hardly assured, thereby avoiding degradation in communication quality.

The host terminal A0, B0, or C0 in the foregoing embodiment is the terminal provided in the communication system S having a structure where the plurality of terminals A0 to 3, B0 to 3, or C0 to 3 constitute one terminal group Ga, Gb, or Gc and a predetermined time slot required to perform communication between desired terminals included in a corresponding terminal group is assigned, and a determination is made upon whether the communication S141, S142, and S144 for initial setting required for a new terminal in A1 to 3, B1 to 3, or C1 to 3 to communicate with the other terminals A0 to 3, B0 to 3, or C0 to 3 can be carried out or not while the time slot already assigned to the terminal group Ga, Gb, or Gc at the step S130 when the new terminal in A1 to 3, B1 to 3, or C1 to 3 is connected.

As a result, different systems can be constituted in accordance with each of the terminal groups Ga, Gb, and Gc, and the communication schemes a, b, and c of the plurality of systems can coexist without interfering with each other. Furthermore, when a terminal in the terminals A1 to 3, B1 to 3, or C1 to 3 that is going to perform communication in each terminal group Ga, Gb, or Gc is newly connected, connection is not achieved as it is, but a determination is made upon whether the communication S141, S142, and S144 for initial setting required to achieve this new connection can be carried out in the already assigned time slot at the step S130. Therefore, the assigned time slot can be used to effect the communication S141, S142, and S144 for initial setting only when the determination at the step S130 is met, and this time slot can be prevented from being used when the determination is not met. As a result, a communication period of information that should be basically transmitted by using the time slot can be prevented from being hardly assured, thus avoiding degradation in communication quality.

Moreover, the communication method according to this embodiment is the communication method by which the terminal group Ga, Gb, or Gc including the plurality of terminals A0 to 3, B0 to 3, or C0 to 3 occupies a predetermined time slot so that desired terminals A0 to 3, B0 to 3, or C0 to 3 in a corresponding terminal group Ga, Gb, or Gc can communicate with each other, whether the communication S141, S142, and S144 for initial setting required for a new terminal to communicate with the other terminals can be carried out or not while the already assigned time slot is determined at the step S130 when the new terminal is connected to effect communication, and the communication for initial setting is performed in a different time slot other than the already assigned time slot or the Best Effort period when the determination is not met.

As a result, the communication schemes a, b, and c of different systems can coexist in accordance with each of the terminal groups Ga, Gb, and Gc without interfering with each other. Furthermore, when a terminal in the terminals A1 to 3, B1 to 3, or C1 to 3 that is going to perform communication in each terminal group Ga, Gb, or Gc is newly connected, connection is not achieved as it is, but whether the communication S141, S142, and S144 for initial setting required to achieve this new connection can be carried out in the already assigned time slot is determined at the step S130, and the communication S141, S142, and S144 for initial setting are performed in a different time slot other than the already assigned time slot or the Best Effort period when the determination is not met. Carrying out the communication S141, S142, and S144 for initial setting by using the time slot in this manner only when the determination is met enables preventing a communication period of information that should be basically transmitted by using the time slot from being hardly assured, thus avoiding degradation in communication quality.

Additionally, the communication processing program according to this embodiment is characterized by allowing the CPU provided in the host terminal A0, B0, or C0 to execute: determining whether the communication S141, S142, and S144 for initial setting required for a newly connected terminal to communicate with other terminals can be performed or not while in an assigned time slot at the step 130 in the case that the terminal group Ga, Gb, or Gc including the plurality of terminals A0 to 3, B0 to 3, or C0 to 3 occupies the time slot and desired terminals A0 to 3, B0 to 3, or C0 to 3 in the terminal group Ga, Gb, or Gc communicate with each other; and informing the newly connected terminal that the communication S141, S142, and S144 for initial setting are performed in other time slot than the time slot already assigned or the Best Effort period at the step S240 or the step S260, when the determination is not met.

Consequently, even if different systems are configured in accordance with each of the terminal groups Ga, Gb, or Gc and the electric power line is shared as a communication path, the communication schemes a, b, and c of the plurality of systems can coexist without interfering with each other. Further, when the terminal in the terminals A1 to 3, B1 to 3, or C1 to 3 that is going to perform communication in each terminal group Ga, Gb, or Gc is newly connected, connection is not achieved as it is, but whether the communication S141, S142, and S144 for initial setting required to achieve this new connection can be effected in the assigned time slot is determined at the step S130, and the communication S141, S142, and S144 for initial setting are effected in a different time slot other than the already assigned time slot or the Best Effort period when the determination is not met.

Carrying out the communication S141, S142, and S144 for initial setting by using the time slot in this manner only when the determination is met enables preventing a communication period of information that should be basically transmitted by using the time slot from being hardly assured, thereby avoiding degradation in communication quality.

1-17. (canceled)

18. A communication system comprising:
a terminal group having a plurality of terminals including one first terminal and at least one second terminal, a predetermined communication path occupancy required to perform communication between desired terminals included in said terminal group being assigned; and
said first terminal including a first determining unit that determines whether execution of communication for initial setting required for a new second terminal to communicate with said other terminals is possible or not while said communication path occupancy assigned to said terminal group yet in the case that said new second terminal is connected.

19. The communication system according to claim 18, wherein:
said first determining unit makes a determination in accordance with a band enabling communication in the assigned communication path occupancy and a band that is used by said plurality of terminals that perform communication.

20. The communication system according to claim 19, wherein:
said first determining unit includes a comparing unit that compares whether a difference between said band enabling communication in the assigned communication path occupancy with said band that is used by said plurality of terminals that perform communication is equal to or above a predetermined threshold value or not.

21. The communication system according to claim 20, wherein:
said second terminal includes a request outputting unit that outputs a request for a band required for communication with said other terminals,
said first terminal includes a band combining unit that combines a band requested by means of said request outputting unit by said second terminal that is in communication with a band requested by means of said request outputting unit by said new second terminal, as said band used by said plurality of terminals that perform communication, and
said comparing unit compares said band enabling communication in the assigned communication path occupancy with a combination result obtained by said band combining unit.

22. The communication system according to claim 18, wherein:
said first terminal includes a first notifying unit that notifies at least said new second terminal of executing said communication for initial setting in a period other than said communication path occupancy assigned to said terminal group when said determination made by said first determining unit is not met.

23. The communication system according to claim 22, further comprising a second determining unit that determines whether a new communication path occupancy is assured or not besides the assigned communication path occupancy when said determination made by said first determining unit is not met.

24. The communication system according to claim 23, wherein:
said first notifying unit notifies at least said new second terminal of executing said communication for initial setting in a non-occupancy prepared as a period that is not occupied by every terminal group, when said determination made by said second determining unit is not met.

25. The communication system according to claim 23, wherein:
said first notifying unit notifies at least said new second terminal of executing said communication for initial setting in a communication path occupancy newly assigned, when said determination made by said second determining unit is met.

26. The communication system according to claim 25, wherein:
said first terminal includes a second notifying unit that notifies other terminal groups than said terminal group of terminating occupation of the newly assigned communication path occupancy, when said communication for initial setting is finished.

27. The communication system according to claim 18, wherein:
said first terminal includes a third determining unit that determines whether execution of communication for disconnection setting is possible or not while the assigned communication path occupancy when communication with at least one of said second terminal becomes impossible, said communication for disconnection setting being required to share communication inexecution information of said second terminal with other second terminals than said at least one of said second terminal.

28. The communication system according to claim 18, wherein:
said first terminal includes a forcible disconnection controlling unit that performs communication for disconnection setting while the assigned communication path occupancy when communication with at least one of said second terminal becomes impossible, said communication for disconnection setting being required to share communication inexecution information of said second terminal with other second terminals than said at least one of said second terminal.

29. The communication system according to claim 18, wherein:
a plurality of said terminal groups are provided through a common communication path formed of the same physical medium with each other, and
communication path occupancies different from each other are assigned respectively to said plurality of terminal groups.

30. The communication system according to claim 29, wherein:
said common communication path connecting said plurality of terminal groups is formed by electric power line communication as said same physical medium.

31. The communication system according to claim 29, wherein:
said common communication path connecting said plurality of terminal groups is formed by wireless communication as said same physical medium.

32. A terminal provided in a communication system, said communication system including a terminal group having a plurality of terminals, a predetermined communication path occupancy required to perform communication between desired terminals included in said terminal group being assigned, said terminal comprising:
a determining unit that determines whether execution of communication for initial setting required for a new terminal to communicate with other terminals is possible or not while said communication path occupancy assigned to said terminal group yet in the case that said new terminal is connected.

33. A communication method by which a terminal group including a plurality of terminals occupies communication path occupancy and desired terminals in said terminal group communicate with each other, said communication method comprising steps of:
a step that determines whether execution of communication for initial setting required for a new terminal to communicate with other terminals is possible or not while said communication path occupancy in the case that said new terminal is connected to perform communication; and
a step that performs said communication for initial setting in a period other than said communication path occupancy when said determination is not met.

34. A communication processing program allowing a computing unit to execute steps, said computing unit being provided in a terminal., a plurality of said terminals forming a terminal group, communication between desired terminals included in said terminal group being performed by using a predetermined communication path occupancy, said steps comprising:
a step that determines whether execution of communication for initial setting required for a terminal newly connected to communicate with other terminals is possible or not while said communication path occupancy; and
a step for informing the newly connected terminal of executing said communication for initial setting in a period other than said communication path occupancy, when said determination is not met.
